(19) United States
(12) Patent Application Publication
(10) Pub. No.: US 2016/0194559 A1
(43) Pub. Date: Jul. 7, 2016

(54) Breathing Plastic Material

(71) Applicant: Ming-Kang Tien, Zhubei City (TW)

(72) Inventor: Ming-Kang Tien, Zhubei City (TW)

(21) Appl. No.: 14/588,988

(22) Filed: Jan. 5, 2015

(51) Int. Cl. C09K 11/64; C09K 11/02

(52) U.S. Cl. CPC C09K 11/646; C09K 11/025

(57) ABSTRACT

There is disclosed a breathing plastic material being obtained by melting a plastic raw material (e.g., polypropylene (PP)) accounting for the proportion of 95%˜50% into a thermo-molten state firstly. Further, porous far-infrared calcined clay accounting for the proportion of 5% to 50% is added to and then mixed with the plastic in the thermo-molten state. After compounding for a period of time, a thermo-melt strip is formed by pressing. Afterwards, the strip is further cut, after a cooling process, into pellets to form plastic pellets of the breathing plastic material. As such, a plastic product made of the plastic pellets may be capable of generating far-infrared ray multi-echelon vibration wave naturally so as to achieve no toxin, deodorization, bacteriostasis, as well as releasing negative ions and releasing bio-spectrum wave having a wavelength ranging from 3 to 14 micrometers timely so as to preserve human health.

### TECHNICAL FIELD OF THE INVENTION

The present invention is related to a breathing plastic material, particularly to a plastic material capable of generating far-infrared ray multi-echelon vibration wave so as to achieve no toxin, deodorization, bacteriostasis, as well as releasing negative ions timely.

### DESCRIPTION OF THE PRIOR ART

It is found that conventional plastic pellets of plastic materials are incapable of generating far-infrared ray multi-echelon vibration wave naturally to inhibit bacterial growth, or releasing bio-spectrum wave having a wavelength ranging from 3 to 14 micrometers in such a way that the fresh-keeping effect of fresh keeping boxes manufactured by the conventional plastic pellets of plastic materials is limited. It is considerably inconvenient owing to incapability of preservation of freshness of foods for a long period of time.

It is apparent that above conventional one is truly not a satisfactory design with a lot of drawbacks, and thus should be improved desirably.

### SUMMARY OF THE INVENTION

In view of above drawbacks of the above-mentioned prior art, an invention of a whole new breathing plastic material is developed and designed by the inventor eventually through unceasing research, experiments and improvements, on the basis of devoted research on various solutions to above drawbacks, in accordance with experience in manufacturing and accumulation of technology obtained from being engaged in various plastic products, so as to eliminate the drawbacks occurring in the prior art.

It is one object of the present invention to provide a breathing plastic material capable of generating far-infrared ray multi-echelon vibration wave naturally so as to achieve no toxin, deodorization, bacteriostasis, as well as releasing negative ions and releasing bio-spectrum wave having a wavelength ranging from 3 to 14 micrometers timely so as to preserve human health.

On the basis of the above object, the breathing plastic material of the present invention is obtained by melting a plastic raw material (e.g., polypropylene (PP)) accounting for the proportion of 95%˜50% into a thermo-molten state firstly. Further, porous far-infrared calcined clay accounting for the proportion of 5% to 50% is added to and then mixed with the plastic in the thermo-molten state. After compounding for a period of time, a thermo-melt strip is formed by pressing. Subsequently, the strip is further cut, after a cooling process, into pellets to form plastic pellets of the breathing plastic material. As such, a plastic product, such as a fresh-keeping box, a ceiling, for example, made of the plastic pellets may be capable of generating far-infrared ray multi-echelon vibration wave naturally so as to achieve no toxin, deodorization, bacteriostasis, as well as releasing negative ions and releasing bio-spectrum wave having a wavelength ranging from 3 to 14 micrometers timely so as to preserve human health.

The objects, shapes, structural features and effects of this invention will be better recognized and understood by way of embodiments, taken in conjunction with the accompanying drawings as follows.

### BRIEF DESCRIPTION OF THE DRAWINGS

FIG. 1 is a diagram showing the appearance of plastic pellets of a breathing plastic material of the present invention.

FIG. 2 is a diagram of a fresh box made of the breathing plastic material of the present invention.

FIG. 3 is a diagram of a ceiling made of the breathing plastic material of the present invention.

### DETAILED DESCRIPTION OF THE PREFERRED EMBODIMENTS

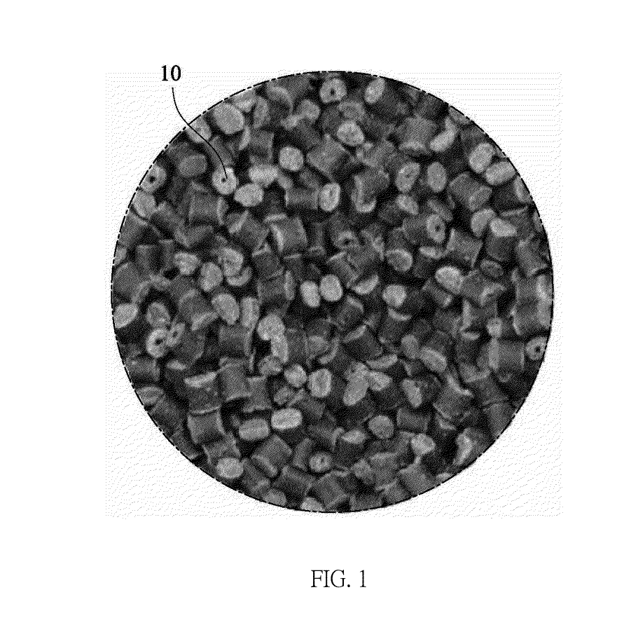

The present invention is related to “a breathing plastic material”. Referring to FIG. 1, the breathing plastic material of the present invention is obtained by melting a plastic raw material (e.g., polypropylene (PP)) accounting for the proportion of 95%˜50% into a thermo-molten state firstly. Further, porous far-infrared calcined clay accounting for the proportion of 5% to 50% is added to and then mixed with the plastic in the thermo-molten state. After compounding for a period of time, a thermo-melt strip is formed by pressing. Subsequently, the strip is further cut, after a cooling process, into pellets to form plastic pellets 10 of the breathing plastic material.

As such, a plastic product made of the plastic pellets may be capable of generating far-infrared ray multi-echelon vibration wave naturally so as to achieve no toxin, deodorization, bacteriostasis, as well as releasing negative ions and releasing bio-spectrum wave having a wavelength ranging from 3 to 14 micrometers timely so as to preserve human health.

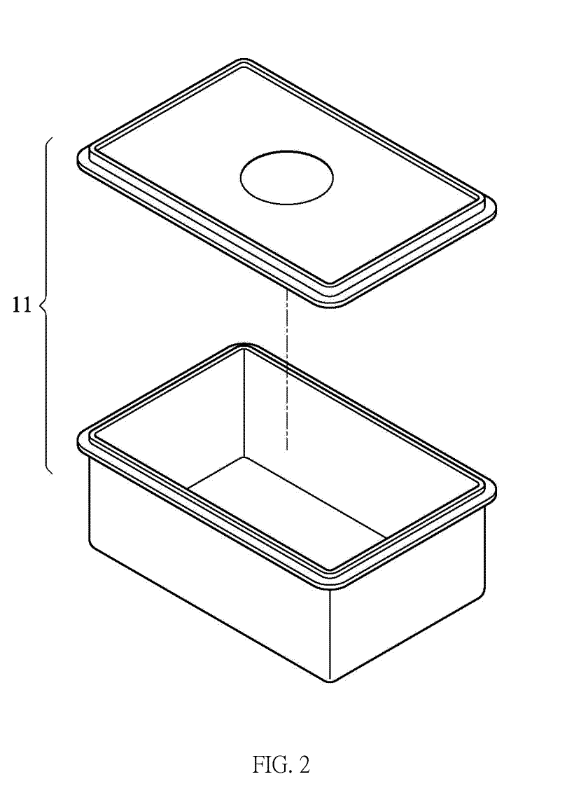

Referring to FIG. 2, the plastic product may be a fresh-keeping box 11, such that the fresh-keeping box 11 made of the plastic pellets 10 may be capable of generating far-infrared ray multi-echelon vibration wave naturally for bacteriostasis up to 82% in 24 hours. Moreover, bio-spectrum wave having a wavelength ranging from 3 to 14 micrometers may be released, such that storage time, which is 2-3 times more than that provided by the commercially available fresh-keeping box, is achieved for keeping eggs, fresh meat, fish and shrimp fresh. The fresh meat, fish and shrimp preserved by freezing, moreover, may not lose original taste after thawed.

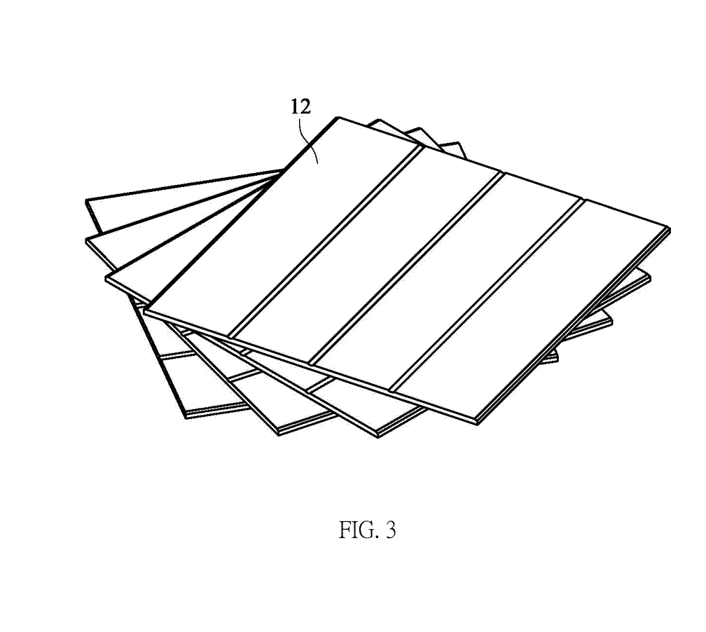

Referring to FIG. 3, the plastic product may be a ceiling 12, in such a way that the ceiling 12 made of the plastic pellets 10 may be capable of generating far-infrared ray multi-echelon vibration wave naturally so as to release far-infrared ray and negative ions for much benefiting human body, as well as releasing bio-spectrum wave having a wavelength ranging from 3 to 14 micrometers so as to preserve human health.

Referring to FIG. 1 again, the plastic raw material may be polypropylene (PP), acrylonitrile-butadiene-styrene resin (ABS), polystyrene (PS), polyethelyne (PE), polycarbonate (PC), high impact polystyrene (HIPS), polyvinyl chloride (PVC), polymethylmethacrylate (PMMA), polyoxymethylene (POM), polyamides (PA), thermoplastic rubber (TPR), polyurethane (PU), styrene-butadiene block copolymer (K resin), clear styrene-butadiene block copolymer (Q resin), polytetrafluoroethylene (PTFE), polylactic acid (PLA) or plastic fiber.

Referring to FIG. 1 again, the porous far-infrared calcined clay is produced in the steps as follows:
(1) picking soil in the manner of crossing through varied soil layers in the vertical section, so as to obtain a soil mixture having mixed soils from varied strata;
(2) calcining the soil mixture at high temperature ranging from 1,300° C. to 2,000° C.; and
(3) obtaining porous far-infrared calcined clay after cooling.

In comparison with the above-mentioned prior art, the breathing plastic material provided by the present invention is further provided with merits as follows.

The plastic product made of the plastic pellets 10 of the breathing plastic material may be capable of generating far-infrared ray multi-echelon vibration wave naturally so as to achieve no toxin, deodorization, bacteriostasis, as well as releasing negative ions and releasing bio-spectrum wave having a wavelength ranging from 3 to 14 micrometers timely so as to preserve human health.

To sum up, the breathing plastic material of the present invention is truly provided with a novel construction which, having been never seen before, is neither published, nor found on the market as any similar products. Thus, novelty should be achieved without doubt. Additionally, advancement is provided in the present invention rather than in the conventional one, due to the fact that the conventional one is hardly comparable with the present invention having specific features and functions. Therefore, the essential conditions for patentability are complied with, and the patent application is filed accordingly.

The foregoing description is only the most preferred embodiment of the present invention, but the structural feature of the present invention is not limited thereto. It would be appreciated by those skilled in the art that variations or modifications may be contemplated readily without departing from the following claims of the invention.

I claim:

1. A breathing plastic material obtained by melting a plastic raw material accounting for the proportion of 95%˜50% into a thermo-molten state firstly, followed by adding porous far-infrared calcined clay accounting for the proportion of 5% to 50% to said plastic in the thermo-molten state and then mixing the former with the latter, compounding for a period of time and then forming, by pressing, a thermo-melt strip; subsequently, further cutting said strip, after a cooling process, into pellets to form plastic pellets of said breathing plastic material.

2. The breathing plastic material according to claim 1, wherein a product of said plastic is a fresh-keeping box or a ceiling.

3. The breathing plastic material according to claim 1, wherein said plastic raw material is polypropylene (PP), acrylonitrile-butadiene-styrene resin (ABS), polystyrene (PS), polyethelyne (PE), polycarbonate (PC), high impact polystyrene (HIPS), polyvinyl chloride (PVC), polymethylmethacrylate (PMMA), polyoxymethylene (POM), polyamides (PA), thermoplastic rubber (TPR), polyurethane (PU), styrene-butadiene block copolymer (K resin), clear styrene-butadiene block copolymer (Q resin), polytetrafluoroethylene (PTFE), polylactic acid (PLA) or plastic fiber.

4. The breathing plastic material according to claim 1, wherein the porous far-infrared calcined clay is produced in the steps as follows:
(1) picking soil in the manner of crossing through varied soil layers in the vertical section, so as to obtain a soil mixture having mixed soils from varied strata;
(2) calcining the soil mixture at high temperature ranging from 1,300° C. to 2,000° C.; and
(3) obtaining porous far-infrared calcined clay after cooling.
